(19) United States
(12) Patent Application Publication
(10) Pub. No.: US 2006/0204629 A1
(43) Pub. Date: Sep. 14, 2006

(54) Pyridinium-betain compounds and their use

(76) Inventors: Imre Blank, Savigny (CH); Martin Grigorov, Epallinges (CH); Thomas Hofmann, Muenster-Roxel (DE)

Correspondence Address: BELL, BOYD & LLOYD LLC, P. O. BOX 1135, CHICAGO, IL, 60690-1135, US

(21) Appl. No.: 10/548,416

(22) PCT Filed: Mar. 10, 2003
(86) PCT No.: PCT/EP03/02594

§ 371 Date: Sep. 8, 2005

(51) Int. Cl. A23L 1/226

(52) U.S. Cl. 426/537

(57) ABSTRACT

The present invention concerns Pyridinium-Betain compounds of the following general formula (A) 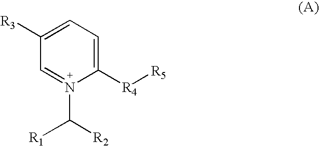
R₁ is H
R₂ is a chemical group formed by a sugar pentose or hexose ring, substituted at C5 or C6, respectively, with an acid residue taken from the group—phosphoryl, sulfonyl, or carboxyl, and R₂ is connected to the pyridaine ring either at C1 or C2 positions
R₃ is taken from the group consisting of OH, including the ionised form O⁻,
R₄ is an aliphatic chain (CH₂)ₙ, where n is the chain length in the range from n=0 to n=4,
R₅ is taken from the group consisting of residues—hydroxy, methoxy, ethoxy, methyl, ethyl, furfurylthio and derivatives, and wherein the counter-ion is taken from the group consisting of sodium, potassium, ammonium, calcium, chloride, carbonate, sulphate, phosphate, and the like.

### BACKGROUND

The so-called umami taste has recently been accepted as the fifth basic taste quality along with the taste modalities sweet, sour, salty, and bitter. This is mainly due to the identification of G protein-coupled receptors for glutamate such as mGluR4 (N. Chaudari et al., Nat. Neurosci. 2000, 3, 113-119.) or the heteromer T1R1+3 receptor (G. Nelson et al., Nature 2002, 416(6877), 199-202), which was reported to be a broadly tuned receptor stimulated by many L-amino acids, in particular also by glutamate. Monosodium glutamate (MSG) is the best-known compound eliciting umami taste (K. Ikeda, J. Tokyo Chem. Soc. 1909, 30, 820-826). Other compounds with similar sensory characteristics belong to the group of purine-5′-nucleotides, such as inosine-5′-monophosphate (IMP) (A. Kuninaka, In: Symposium on Foods: The Chemistry and Physiology of Flavors; Schultz, H. W.; Day, E. A.; Libbey, L. M., Eds.; AVI Publishing Company: Westport, Conn., 1967; pp 515-535). These compounds occur in many savoury foods such as meat, fish, seafood, and mushrooms (S. Yamaguchi, J. Food Sci. 1967, 32, 473-478). An interesting property of umami compounds is their mutual taste synergism. The synergistic effects between MSG and IMP have been investigated and reported in the literature (S. Yamaguchi et al., J. Food Sci. 1971, 36, 1761-1765).

### SUMMARY

The present invention concerns Pyridinium-Betain compounds and their use as taste modifying compounds (taste modulators). The term ‘taste modifying’ is defined as the ability to enhance or to reduce the sensory properties of taste compounds.

The invention discloses a series of homologous betaine pyridinium compounds and their use as agents with taste-modifying properties. By taste-modifying properties we understand the ability of the compounds to enhance or to reduce the sensory quality of taste-active compounds. These taste-modifying compounds can be used as such or generated in-situ by thermal or enzymatic reactions.

The aim of the present invention is to identify compounds having taste modifying properties, for example to enhance the overall umami sensory quality of samples containing taste-active compounds.

The discovery of the compounds was made through the use of molecular modelling and quantitative-structure activity relationship (QSAR) methods. The series was specifically designed to match closely in sapophoric space known enhancers of umami taste, such as inosine monophosphate (IMP) or guanosine monophosphate (GMP). Here we mean by the term sapophore the minimum set of chemical features needed to be present on a molecule in order this to elicit certain taste, in our case umami taste.

Additional features and advantages are described herein, and will be apparent from, the following Detailed Description and the figures.

### BRIEF DESCRIPTION OF THE FIGURES

FIG. 1 illustrates mapping of the sapophore for a umami taste enhancer IMP and for the Pyridinium-Betain compound.

### DETAILED DESCRIPTION

The present invention concerns compounds called Pyridinium-Betain compounds of the general formula (A):

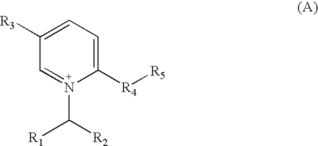

wherein:

R₁ is H

R₂ is a chemical group formed by a sugar pentose or hexose ring, substituted at C5 or C6, respectively, with an acid residue taken from the group—phosphoryl, sulfonyl, or carboxyl, and R₂ is connected to the pyridaine ring either at C1 or C2 positions, wherein C1, C2, C5 and C6 belongs to the sugar moiety,

R₃ is OH, including the ionised form O⁻,

R₄ is an aliphatic chain (CH₂)ₙ, where n is the chain length in the range from n=0 to n=4,

R₅ is taken from the group consisting of residues—hydroxy, methoxy, ethoxy, iso-propoxy, propoxy, allyloxy, methyl, ethyl, phenyl, methylthio, ethylthio, ethoxyethylthio, ethoxycarbonylethylthio, furfurylthio, tetrahydrofurfurylthio, isopentenylthio, (beta-methylallyl)thio, (gamma-methylallyl)thio, and derivatives

and wherein the counter-ion is taken from the group consisting of sodium, potassium, ammonium, calcium, magnesium, chloride, nitrate, carbonate, sulphate, phosphate, and the like.

In a preferred embodiment of the compound of the invention, R₂ is the rest of a sugar phosphate, R₃ is OH including the ionised form O⁻, R₄ is CH₂, and R₅ is a hydroxyl group (OH), including the ionised form O⁻.

The compounds of the general formula (A) have zwitterionic character in a broad pH range. As shown below, the zwitterionic structure (A2) dominates under slightly acidic and neutral conditions with the negative charge primarily located at the phosphate group attached to the sugar moiety (R₂ in (A)). Under basic conditions represented by the structure (A3), the negative charge may be located at the phosphate group attached to the sugar moiety (group R₂ in (A)) and at the hydroxyl group directly attached to the pyridinium ring (group R₃ in (A)). Under strongly acidic conditions, both the phosphate and hydroxyl groups are protonated, as shown in the structure (A1). Depending on the pH of an aqueous solution containing the compounds of the general formula (A), the structures (A1), (A2) and (A3) may exist in an equilibrium.

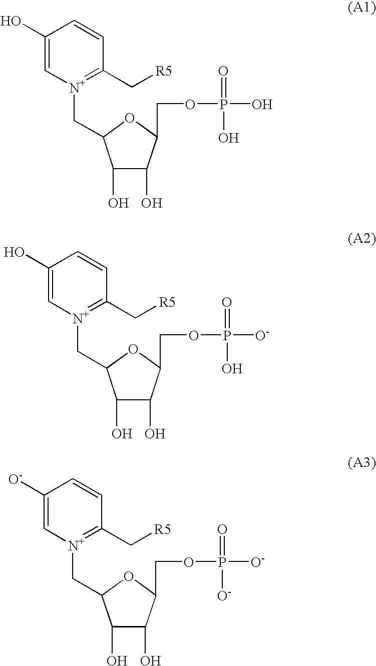

The above-mentioned compounds are reaction products from reducing sugars or their derivatives with amino compounds and their derivatives.

The amount of the compound (A) is comprised between 0.01 and 3000 mg/kg of the whole composition.

In addition, the present invention concerns a process for the preparation of the compounds (A), wherein said compound is obtained by synthesis using 5-(hydroxymethyl)-2-furanaldehyde (HMF) and the corresponding amino sugar or derivatives thereof. Another way of proceeding is to use HMF producing precursors, such mono- and polysaccharides, and the corresponding amino sugar or derivatives thereof.

The following examples illustrate the invention in more details.

Rationale

The above-mentioned compounds were designed as umami taste enhancers. This property was deduced by virtual screening of the compounds through a sapophoric model. The model was produced in order to capture most of the information contained in structure-activity data of molecules possessing umami taste enhancing properties. Such molecules were collected through the available literature, such as S. Yamaguchi and K. Ninomyia, Food Rev. Int. 14(2&3), 123-138, 1989, and references mentioned therein.

### EXAMPLE 1

### Schematic Synthesis Procedure

Compounds of the general formula (A) can be prepared using suitable starting materials and well-known protection and coupling methods described in organic chemistry (J. March, Advanced Organic Chemistry: Reactions, Mechanisms, and Structure, 4^{th} edition, J. Wiley & Sons: New York, 1992).

As an example, 5-hydroxymethylfurfural (HMF), a well-known sugar degradation product, coupled with an amino sugar derivative results in compound (A4) according to the general method described in the literature (Koch et al., Carbohydrate Chemistry, 1988, 313, 117-123).

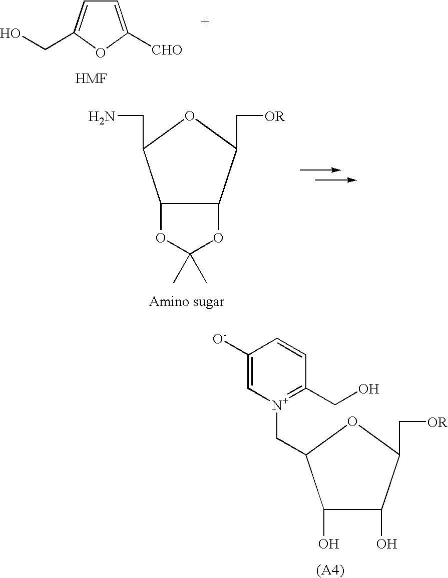

### EXAMPLE 2

### Synthesis Via Reductive Amination of HMF

Alternatively, compounds of the general formula (A) can be prepared by reductive amination of 5-hydroxymethylfurfural (HMF) according to the general procedure described in the literature (Müller et al., Tetrahedron, 1998, 54, 10703-10712).

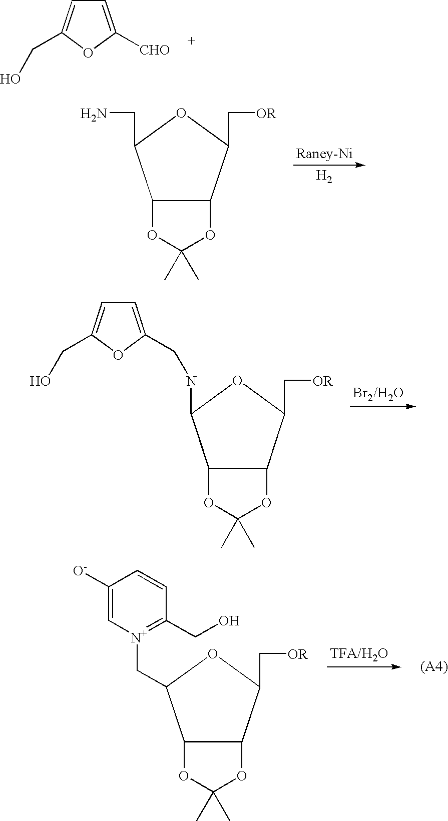

### EXAMPLE 3

### Enhancement of the Umami Taste Modality

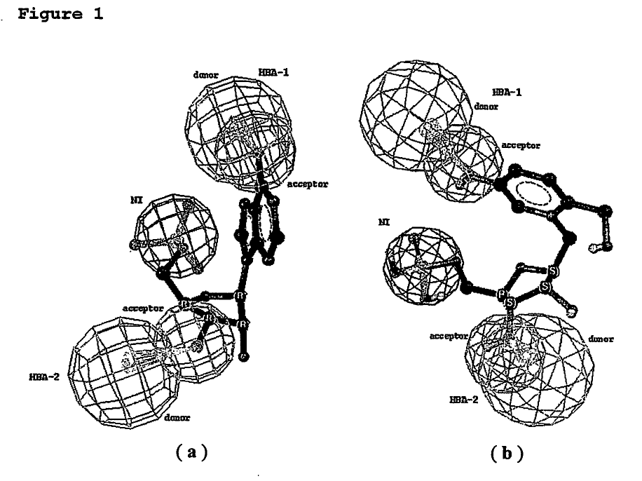

In FIG. 1, we show how the well-known umami taste enhancer IMP projects on the optimal sapophore space (a), as well as the mapping in the same space of a proposed betaine-pyridinium compound (b). In light grey are depicted the locations of hydrogen-bond acceptor sites (HBA), while in dark grey are depicted the locations of negatively ionisable groups (NI). The spheres diameters account for tolerances in these positions. Detailed geometric properties of the optimal sapophore are given in Table I.

TABLE I

| | | | | | Bond | |
|---|---|---|---|---|---|---|
| | | Hydrogen | | Hydrogen | Site | |
| | | Acceptor | Bond | Acceptor | 2, 2 | Negatively |
| | | HBA | Site 1, 1 | HBA | Do- | Ionisable |
| | | Acceptor | Donor | Acceptor | nor | Site, NI |
| Tolerances, Å | | 1.60 | 2.20 | 1.60 | 2.20 | 1.60 |
| Co-ordinates, | X | 4.44 | 6.23 | −1.48 | −1.57 | 2.09 |
| | Y | 2.40 | 2.25 | −2.39 | −5.33 | −1.63 |
| | Z | −1.30 | 1.10 | 0.90 | 0.90 | −2.22 |

Inter-feature distances, Å

| | | | | | | |
|---|---|---|---|---|---|---|
| HBA-1, | acceptor | 0.0 | — | — | — | — |
| | donor | 3.0 | 0.0 | — | — | — |
| HBA-2 | acceptor | 7.8 | 9.0 | 0.0 | — | — |
| | donor | 10.0 | 10.9 | 3.0 | 0.0 | — |
| NI | | 4.8 | 6.0 | 4.4 | 6.1 | 0.0 |

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. Pyridinium-Betain compounds of the following general formula (A) 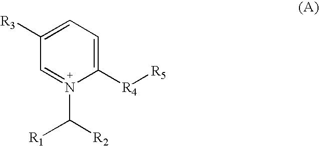
wherein:
R₁ is H
R₂ is a chemical group formed by a sugar pentose or hexose ring, substituted at C5 or C6, respectively, with an acid residue selected from the group consisting of—phosphoryl, sulfonyl, or carboxyl, and R₂ is connected to the pyridaine ring either at C1 or C2 positions, wherein C1, C2, C5 and C6 belongs to the sugar moiety,
R₃ is selected from the group consisting of OH, including the ionised form O⁻,
R₄ is an aliphatic chain (CH₂)ₙ, where n is the chain length in the range from n=0 to n=4,
R₅ is selected from the group consisting of residues—hydroxy, methoxy, ethoxy, iso-propoxy, propoxy, allyloxy, methyl, ethyl, phenyl, methylthio, ethylthio, ethoxyethylthio, ethoxycarbonylethylthio, furfurylthio, tetrahydrofurfurylthio, isopentenylthio, (beta-methylallyl)thio, (gamma-methylallyl)thio, and derivatives,
and wherein the counter-ion is selected from the group consisting of sodium, potassium, ammonium, calcium, magnesium, chloride, nitrate, carbonate, sulphate, phosphate, and the like.

2. Pyridinium-Betain compounds according to claim 1, wherein R₂ is a sugar phosphate, R₃ is OH including the ionised form O⁻, R₄ is CH₂, and R₅ is a hydroxyl group (OH), including the ionised form O⁻.

3. Pyridinium-Betain compounds according to claim 1, wherein R₂ is a sugar phosphate, R₃ is OH including the ionised form O⁻, R₄ is CH₂, and R₅ is furfurylthio radical.

4. A method of preparing a food comprising adding a Pyridinium-Betain compound comprising the following general formula (A) 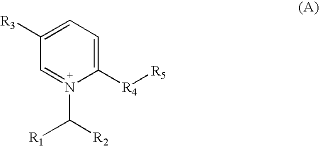
wherein:
R₁ is H
R₂ is a chemical group formed by a sugar pentose or hexose ring, substituted at C5 or C6, respectively, with an acid residue selected from the group consisting of—phosphoryl, sulfonyl, or carboxyl, and R₂ is connected to the pyridaine ring either at C1 or C2 positions, wherein C1, C2, C5 and C6 belongs to the sugar moiety
R₃ is selected from the group consisting of OH, including the ionised form O⁻,
R₄ is an aliphatic chain (CH₂)ₙ, where n is the chain length in the range from n=0 to n=4,
R₅ is selected from the group consisting of residues—hydroxy, methoxy, ethoxy, iso-propoxy, propoxy, allyloxy, methyl, ethyl, phenyl, methylthio, ethylthio, ethoxyethylthio, ethoxycarbonylethylthio, furfurylthio, tetrahydrofurfurylthio, isopentenylthio, (beta-methylallyl)thio, (gamma-methylallyl)thio, and derivatives,
and wherein the counter-ion is selected from the group consisting of sodium, potassium, ammonium, calcium, magnesium, chloride, nitrate, carbonate, sulphate, phosphate, and the like to a food composition to enhance the umami taste of a compound having said functionality.

5. The method according to claim 4, wherein the food composition is selected from the group consisting of culinary products, and petfood.

6. The method according to claim 4, wherein the amount of the Pyridinium-Betain compound (A) is comprised between 0.01 and 3000 mg/kg of the whole composition.

7. A process for the preparation of a Pyridinium-Betain compounds the following general formula (A) 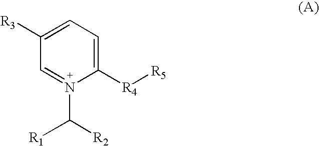
wherein:
R₁ is H
R₂ is a chemical group formed by a sugar pentose or hexose ring, substituted at C5 or C6, respectively, with an acid residue selected from the group consisting of—phosphoryl, sulfonyl, or carboxyl, and R₂ is connected to the pyridaine ring either at C1 or C2 positions, wherein C1, C2, C5 and C6 belongs to the sugar moiety
R₃ is selected from the group consisting of OH, including the ionised form O⁻,
R₄ is an aliphatic chain (CH₂)ₙ, where n is the chain length in the range from n=0 to n=4,
R₅ is selected from the group consisting of residues—hydroxy, methoxy, ethoxy, iso-propoxy, propoxy, allyloxy, methyl, ethyl, phenyl, methylthio, ethylthio, ethoxyethylthio, ethoxycarbonylethylthio, furfurylthio, tetrahydrofurfurylthio, isopentenylthio, (beta-methylallyl)thio, (gamma-methylallyl)thio, and derivatives,
and wherein the counter-ion is selected from the group consisting of sodium, potassium, ammonium, calcium, magnesium, chloride, nitrate, carbonate, sulphate, phosphate, and the like, wherein the Pyridinium-Betain obtained by synthesis using 5-(hydroxymethyl)-2-furanaldehyde (HMF) and the corresponding amino amino sugars or derivatives thereof.

8. A process for the preparation of a Pyridinium-Betain compound comprising the following general formula (A) 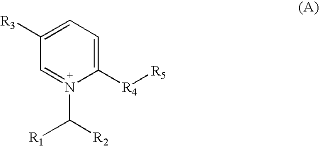
wherein:
R₁ is H
R₂ is a chemical group formed by a sugar pentose or hexose ring, substituted at C5 or C6, respectively, with an acid residue selected from the group consisting of—phosphoryl, sulfonyl, or carboxyl, and R₂ is connected to the pyridaine ring either at C1 or C2 positions, wherein C1, C2, C5 and C6 belongs to the sugar moiety
R₃ is selected from the group consisting of OH, including the ionised form O⁻,
R₄ is an aliphatic chain (CH₂)ₙ, where n is the chain length in the range from n=0 to n=4,
R₅ is selected from the group consisting of residues—hydroxy, methoxy, ethoxy, iso-propoxy, propoxy, allyloxy, methyl, ethyl, phenyl, methylthio, ethylthio, ethoxyethylthio, ethoxycarbonylethylthio, furfurylthio, tetrahydrofurfurylthio, isopentenylthio, (beta-methylallyl)thio, (gamma-methylallyl)thio, and derivatives,
and wherein the counter-ion is selected from the group consisting of sodium, potassium, ammonium, calcium, magnesium chloride, nitrate, carbonate, sulphate, phosphate, and the like, wherein the Pyridinium-Betain compound is obtained by reacting HMF producing precursors with the corresponding amino sugars or derivatives thereof.

9. A process for the preparation of the Pyridinium-Betain compounds of claim 8, wherein the HMF producing precursors are selected from the group consisting of mono- and polysaccharides, and degradation products thereof.
